(19) United States
(12) Patent Application Publication
(10) Pub. No.: US 2011/0248968 A1
(43) Pub. Date: Oct. 13, 2011

(54) FLAT PANEL DISPLAY DEVICE

(76) Inventor: Mi-Sook Suh, Yongin-city (KR)

(21) Appl. No.: 12/939,102

(22) Filed: Nov. 3, 2010

(30) Foreign Application Priority Data
Apr. 13, 2010 (KR) 10-2010-0033822

(51) Int. Cl. G09G 5/00; G09G 3/36; G09G 3/32

(52) U.S. Cl. 345/204; 345/76; 345/87

(57) ABSTRACT

A flat panel display device having a reduced dead space. The flat panel display device includes a pixel unit having a plurality of pixels, and a built-in circuit unit in which a driver circuit for driving the pixels is formed. In the flat panel display device, the built-in circuit unit is disposed to partially overlap with the pixel unit.

### CROSS-REFERENCE TO RELATED APPLICATION

This application claims priority to and the benefit of Korean Patent Application No. 10-2010-0033822, filed on Apr. 13, 2010, in the Korean Intellectual Property Office, the entire content of which is incorporated herein by reference.

### BACKGROUND

1. Field

The following description relates to a flat panel display device, and more particularly, to a flat panel display device having a reduced dead space.

2. Description of the Related Art

Recently, various types of flat panel display devices that are lighter in weight and smaller in volume than a comparable cathode ray tube display device have been developed. These flat panel display devices include a liquid crystal display device, a field emission display device, a plasma display panel, an organic light emitting display device, and the like.

A panel of a flat panel display device includes a pixel unit (display unit or display region) having a plurality of pixels, and a built-in circuit unit formed together with the pixels on the panel to apply an electrical signal to the pixels.

As an example, the built-in circuit unit may include a scan driver for sequentially supplying a scan signal to the pixels.

Here, the built-in circuit unit supplies an electrical signal such as the scan signal to the pixels, and the pixels display an image in accordance with the electrical signal.

Also, regions other than the region occupied by the pixel unit in the panel are commonly referred to as a dead space. In addition to the built-in circuit unit, lines such as signal lines and power lines are disposed in the dead space.

Since the dead space restricts the ratio of the area occupied in the entire area of the panel, there is a need to reduce the dead space.

### SUMMARY

An aspect of an embodiment of the present invention is directed toward a flat panel display device having a reduced dead space.

According to an embodiment of the present invention, there is provided a flat panel display device including: a pixel unit including a plurality of pixels; and a built-in circuit unit including a driver circuit configured to drive the pixels. Here, the built-in circuit unit is disposed to partially overlap with the pixel unit.

In one embodiment, each of the pixels includes: a pixel circuit comprising one or more transistors, a first electrode electrically connected to the pixel circuit and above the pixel circuit, and a second electrode facing the first electrode; and the built-in circuit unit is disposed to overlap with first and second electrodes of a set of the pixels. In one embodiment, the built-in circuit unit includes a plurality of transistors formed in the same layer as the one or more transistors of the pixel circuit; and some of the plurality of transistors are disposed to overlap with the first and second electrodes of the set of the pixels and to be below the first and second electrodes. In one embodiment, the pixels are configured to emit light in the overlapping region of the first and second electrodes so as to display an image.

In one embodiment, each of the pixels includes: a pixel circuit including a drive transistor; and an organic light emitting diode including a first electrode electrically connected to the drive transistor and above the drive transistor, a light emitting layer on the first electrode, and a second electrode on the light emitting layer. The built-in circuit unit is disposed to overlap with the first electrodes, the light emitting layers and the second electrodes of some of the pixels.

In one embodiment, each of the pixels includes: a pixel circuit including one or more transistors, a pixel electrode electrically connected to the one or more transistors and above the one or more transistors, a common electrode facing the pixel electrode, and a liquid crystal layer interposed between the pixel and common electrodes. The built-in circuit unit is disposed to overlap with the pixel electrodes, the liquid crystal layer and the common electrodes of some of the pixels.

In one embodiment, each of the pixels includes: a pixel circuit including one or more transistors, a first electrode electrically connected to the pixel circuit and above the pixel circuit, a second electrode facing the first electrode, and an emission region formed in the overlapping region of the first and second electrodes. In at least a set of the pixels, pixel circuit regions, having the pixel circuits formed therein, and the emission regions are disposed to cross each other. In one embodiment, the pitch of the emission regions is formed to be wider than that of the pixel circuit regions. In one embodiment, the set of the pixels are disposed so that a corresponding pixel circuit region of the pixel circuit regions is not overlapped with a corresponding emission region of the emission regions, and each of the emission regions is disposed to at least partially overlap with a neighboring pixel region of the pixel regions or the built-in circuit unit.

As described above, according to an embodiment of the present invention, the built-in circuit unit is disposed to partially overlap with the pixel unit, thereby ensuring an emission region for displaying an image and effectively reducing a dead space.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram schematically showing a configuration of a flat panel display device.

FIGS. 2A and 2B are circuit diagrams respectively showing two different embodiments of a pixel provided to the flat panel display device shown in FIG. 1.

FIG. 3 is a plan view showing a panel of a flat panel display device according to an embodiment of the present invention.

FIG. 4 is an enlarged view of region A of FIG. 3.

FIG. 5 is a sectional view showing an example of the panel shown in FIG. 3.

FIG. 6 is a sectional view showing another example of the panel shown in FIG. 3.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

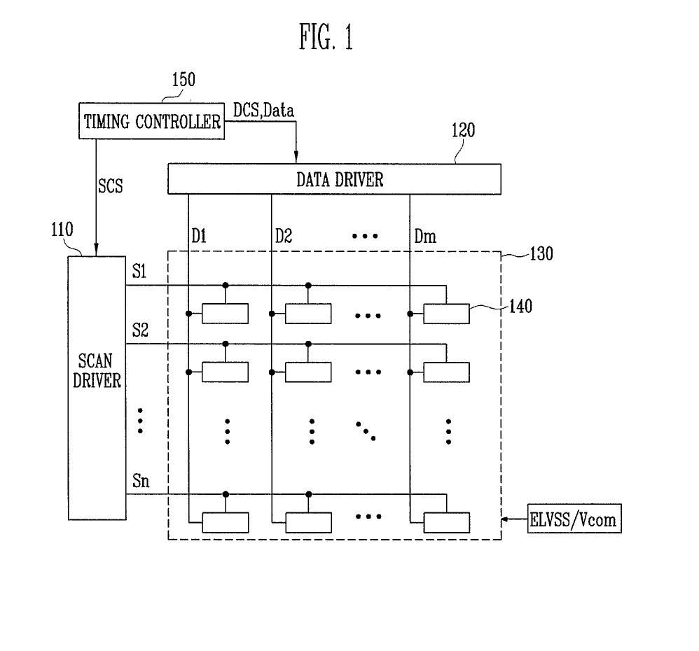

FIG. 1 is a block diagram schematically showing a configuration of a flat panel display device.

Referring to FIG. 1, the flat panel display device includes a pixel unit (display unit or display region) 130 having a plurality of pixels 140 positioned at crossing regions of scan lines S1 to Sn with data lines D1 to Dm; a scan driver 110 for driving the scan lines S1 to Sn; a data driver 120 for driving the data lines D1 to Dm; and a timing controller 150 for controlling the scan driver 110 and the data driver 120.

The scan driver 110 receives a scan drive control signal SCS supplied from the timing controller 150. The scan driver 110 that receives the scan drive control signal SCS from the timing controller 150 generates a scan signal and supplies the generated scan signal sequentially to the scan lines S1 to Sn.

The data driver 120 receives a data drive control signal DCS and a data Data, supplied from the timing controller 150. The data driver 120 that receives the data drive control signal DCS and the data, supplied from the timing controller 150, generates a data signal and supplies the generated data signal to the data lines D1 to Dm in synchronization with the scan signal.

The timing controller 150 generates the data drive control signal DCS and the scan drive control signal SCS, corresponding to synchronization signals supplied from the exterior of the flat panel display device. The data drive control signal DCS generated from the timing controller 150 is supplied to the data driver 120, and the scan drive control signal SCS generated from the timing controller 150 is supplied to the scan driver 110.

Here, the data drive control signal DCS may include a source start pulse, a source shift clock, a source output enable signal and the like. The scan drive control signal SCS may include a gate start pulse, a gate shift clock, a gate output enable signal and the like.

The pixel unit 130 has the plurality of pixels 140 positioned at crossing regions of the scan lines S1 to Sn with the data lines D1 to Dm. A selected pixel of the pixels 140 is selected when a scan signal is supplied to a corresponding scan line S coupled to the selected pixel, and emits light with luminance in accordance with a data signal supplied from a corresponding data line D to exterior thereof. Accordingly, an image can be displayed in the pixel unit 130 by the light emitted from the various pixels 140.

The flat panel display device may include an organic light emitting display device, a liquid crystal display device and the like.

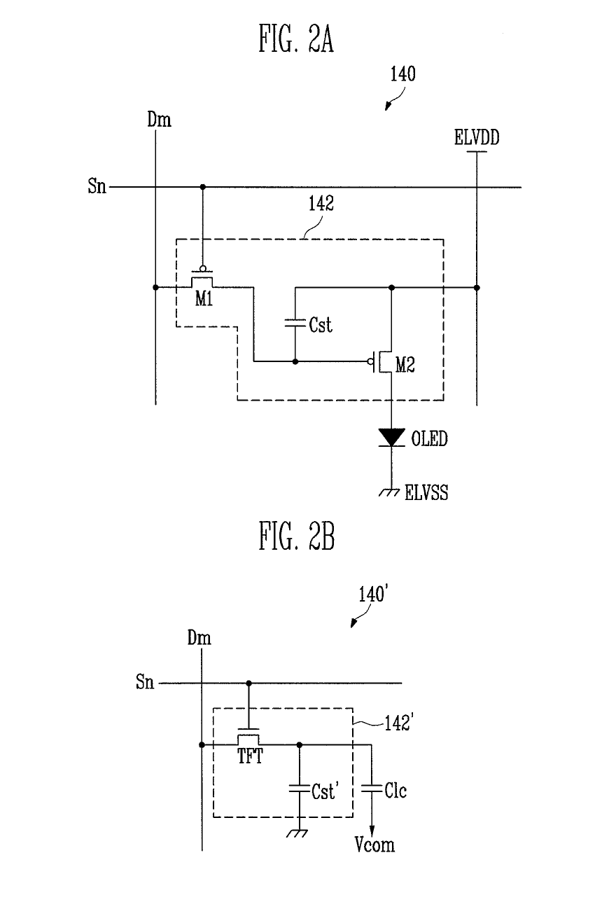

FIGS. 2A and 2B are circuit diagrams respectively showing two different embodiments of a pixel provided to the flat panel display device shown in FIG. 1.

Here, FIG. 2A shows an example of a pixel included in an organic light emitting display device, and FIG. 2B shows an example of a pixel included in a liquid crystal display device. For convenience of illustration, a pixel coupled to an n-th scan line Sn and an m-th data line Dm will be shown in FIGS. 2A and 2B.

Referring to FIG. 2A, the pixel 140 includes an organic light emitting diode OLED and a pixel circuit 142 coupled to the data and scan lines Dm and Sn to control the organic light emitting diode OLED.

An anode electrode of the organic light emitting diode OLED is coupled to the pixel circuit 142, particularly a drive transistor M2, and a cathode electrode of the organic light emitting diode OLED is coupled to a second pixel power source ELVSS. The organic light emitting diode OLED generates light with luminance corresponding to current supplied from the pixel circuit 142.

When a scan signal is supplied to the scan line Sn, the pixel circuit 142 controls the amount of current supplied to the organic light emitting diode OLED, in accordance with a data signal supplied from the data line Dm.

To this end, the pixel circuit 142 includes a switching transistor M1 coupled to the scan and data lines Sn and Dm; the drive transistor M2 coupled between a first pixel power source ELVDD and the anode electrode of the organic light emitting diode OLED; and a storage capacitor Cst coupled between gate and source electrodes of the drive transistor M2.

A first electrode of the switching transistor M1 is coupled to the data line Dm, and a second electrode of the switching transistor M1 is coupled to the gate electrode of the drive transistor M2 and one electrode of the storage capacitor Cst. Here, the first and second electrodes of the switching transistor M1 are different electrodes from each other. For example, if the first electrode is a source electrode, the second electrode is a drain electrode (or vise versa). A gate electrode of the switching transistor M1 is coupled to the scan line Sn.

When a scan signal is supplied from the scan line Sn, the switching transistor M1 is turned on to supply a data signal supplied from the data line Dm to the storage capacitor Cst. At this time, a voltage corresponding to the data signal is charged (stored) into the storage capacitor Cst.

A first electrode of the drive transistor M2 is coupled to the first pixel power source ELVDD, and a second electrode of the drive transistor M2 is coupled to the anode electrode of the organic light emitting diode OLED. The gate electrode of the drive transistor M2 is coupled to the one electrode of the storage capacitor Cst.

The drive transistor M2 controls the amount of current that flows from the first pixel power source ELVDD to the second pixel power source ELVSS via the organic light emitting diode OLED, in accordance with the voltage stored in the storage capacitor Cst.

At this time, the organic light emitting diode OLED generates light corresponding to the amount of current supplied from the drive transistor M2.

The pixel 140 shown in FIG. 2A discloses an example of the pixel of the organic light emitting display device having a relatively simple structure. It will be apparent the pixel 140 may be variously and suitably modified to include, e.g., one or more other transistors and/or capacitors.

Referring to FIG. 2B, an example of the pixel included in the liquid crystal display device will be described in more detail. The pixel 140′ includes a liquid crystal capacitor Clc and a pixel circuit 142′ coupled to the liquid crystal capacitor Clc to control the liquid crystal capacitor.

The liquid crystal capacitor Clc is coupled to a second electrode of a transistor TFT and a storage capacitor Cst′. The liquid crystal capacitor Clc can be equivalently expressed by a pixel electrode, a common electrode and a liquid crystal layer interposed therebetween.

When the transistor TFT is turned on, the liquid crystal capacitor Clc controls the light transmittance of liquid crystals, corresponding to a voltage stored in the storage capacitor Cst′.

The pixel circuit 142′ includes a transistor coupled to the scan and data lines Sn and Dm, and a storage capacitor Cst′ coupled to the transistor TFT.

A first electrode of the transistor TFT is coupled to the data line Dm, and a second electrode of the transistor TFT is coupled to the storage capacitor Cst′ and one electrode of the liquid crystal capacitor Clc. Here, the first and second electrodes of the transistor TFT are different electrodes from each other. For example, if the first electrode is a drain electrode, the second electrode is a source electrode (or vise versa). A gate electrode of the transistor TFT is coupled to the scan line Sn.

When a scan signal is supplied from the scan line Sn, the transistor TFT is turned on to supply a data signal supplied from the data line Dm to the storage capacitor Cst′.

Then, a voltage corresponding to the data signal supplied from the data line Dm via the transistor TFT is charged (stored) into the storage capacitor Cst′, and the charged voltage is maintained during one frame.

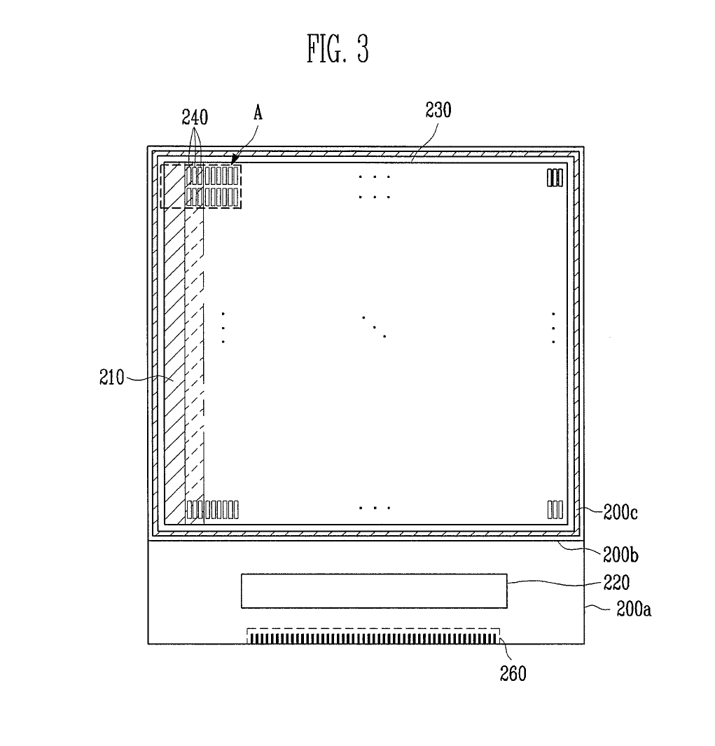

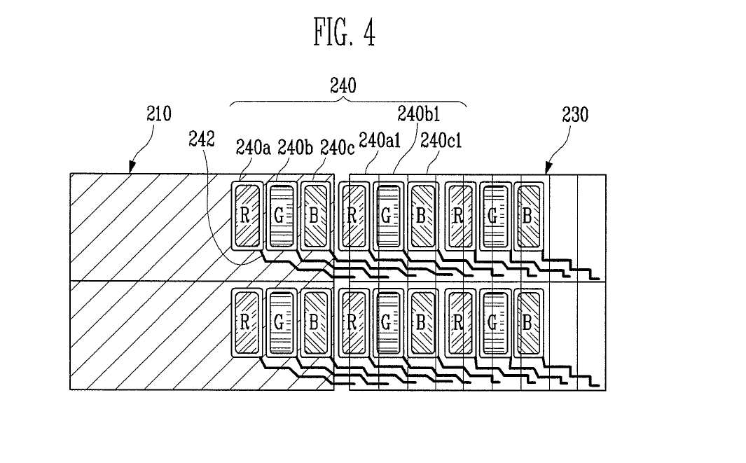

FIG. 3 is a plan view showing a panel of a flat panel display device according to an embodiment of the present invention. FIG. 4 is an enlarged view of region A of FIG. 3.

Referring to FIG. 3, the panel includes a lower substrate 200a on which a pixel unit 230 having a plurality of pixels 240 and a built-in circuit unit 210 having a driver circuit for driving the pixels 240 are formed, a driver IC 220 and the like are mounted, and a pad unit 260 is formed at one side thereof; an upper substrate 200b disposed on the lower substrate 200a in the region in which at least the pixel unit 230 and the built-in circuit unit 210 are formed; and a sealing material 200c at along an edge of the region in which the lower and upper substrates 200a and 200b are overlapped and interposed therebetween so as to seal at least the pixel unit 230 and the built-in circuit unit 210.

Here, the built-in circuit unit 210 is a unit (region) in which a driver circuit for driving pixels, such as a scan driver and/or an emission control driver, is formed. In some cases, the built-in circuit unit 210 may further include a test circuit or the like.

The built-in circuit unit 210 may be formed to include a plurality of transistors. The built-in circuit unit 210 may be formed together with the pixels 240 in the process of forming the pixels 240 on the lower substrate 200a.

For example, in the process of forming the transistors (M1 and M2 of FIG. 2A or TFT of FIG. 2B, and the like) and the capacitors (Cst of FIG. 2A or Cst′ of FIG. 2B, and the like), provided to the pixels 240, the built-in circuit unit 210 may be formed together with the transistors on the lower substrate 200a.

That is, the built-in circuit unit 210 may be configured to include a plurality of transistors simultaneously (or currently or commonly) formed in the same layer as the transistors and the like, provided to the pixels 240.

Here, the configuration of the circuit such as the scan driver and/or the emission control driver, which includes the plurality of transistors and may be formed in the built-in circuit unit 210, can be embodied as various suitable embodiments in the art, and the present invention is not thereby limited.

The driver IC 220 may also be configured to include a data driver and the like. The driver IC 220 may be mounted on one side of the panel.

The pad unit 260 includes a plurality of pads for receiving drive power sources and drive signals supplied from the exterior of the panel. The pad unit 260 may be disposed at one edge (e.g., at a lower edge) of the lower substrate 200a, adjacent to the driver IC 220.

In this embodiment, the built-in circuit unit 210 is partially overlapped with the pixel unit 230.

Particularly, the built-in circuit unit 210 is disposed not to overlap with a pixel circuit region in which a pixel circuit including one or more transistors is formed. The built-in circuit unit 210 is disposed to overlap with an emission region electrically connected to the pixel circuit at an upper portion of the pixel circuit to emit light under the control of the pixel circuit.

As an example, referring to FIG. 4, in the pixel 240 including red, green and blue sub-pixels, emission regions 240a, 240b and 240c of red, green and blue sub-pixels of some pixels, positioned at the side of the built-in circuit unit 210, are disposed at an upper portion of the built-in circuit unit 210 to overlap with the built-in circuit unit 210. In addition, pixel circuit regions 240a1, 240b1 and 240c1 in which pixel circuits of the red, green and blue sub-pixels of these pixels are disposed not to overlap with the built-in circuit unit 210.

That is, the pixels 240 are disposed so that the pixel circuit regions 240a1, 240b1 and 240c1 are not overlapped with the emission regions 240a, 240b and 240c. However, some of the pixels may be disposed so that the emission regions 240a, 240b and 240c are at least partially overlapped with the pixel circuit regions of neighboring pixels or the built-in circuit unit 210.

To this end, in at least some of the pixels 240, the pixel circuit regions 240a1, 240b1 and 240c1 in which the pixel circuits are formed and the emission regions 240a, 240b and 240c are disposed to overlap with (or cross) each other. The pixel circuit regions 240a1, 240b1 and 240c1 and the emission regions 240a, 240b and 240c may be electrically connected through connection lines 242, respectively.

Particularly, in order to ensure a proper size for the emission regions to display an image and to effectively reduce a dead space, the pitch of pixel circuit regions may be reduced to be as narrow as needed to allow the built-in circuit unit 210 to be in the interior of the pixel unit 230.

That is, in this embodiment, the pitch of the emission regions 240a, 240b and 240c may be formed to be wider than that of the pixel circuit regions 240a1, 240b1 and 240c1.

For convenience of illustration, it has been described in FIG. 4 that the emission regions 240a, 240b and 240c of one unit pixel 240 including red, green and blue sub-pixels for each horizontal line are overlapped with the built-in circuit unit 210. However, the number of pixels 240 overlapped with the built-in circuit unit 210 may be variously and suitably modified. It will be apparent that in an embodiment of the present invention only the emission regions of some sub-pixels of the unit pixel 240 (and not the pixel circuit regions of these sub-pixels) are overlapped with the built-in circuit unit 210.

As described above, according to this embodiment, the built-in circuit unit 210 is disposed to partially overlap with the pixel unit 230, thereby ensuring the large size of emission regions for displaying an image and effectively reducing a dead space.

FIG. 5 is a sectional view showing an example of the panel shown in FIG. 3. Particularly, an example of the panel of the organic light emitting display device is shown in FIG. 5. For convenience of illustration, in FIG. 5, the illustration of components unnecessary in the description of this embodiment will be omitted.

Referring to FIG. 5, a plurality of transistors 202′ are formed in a built-in circuit unit on a lower substrate 200a. In addition, a pixel circuit including one or more transistors 202 is formed in a pixel circuit region of each pixel.

At this time, a switching transistor M1, a drive transistor M2, a storage capacitor Cst and the like may be included in the pixel circuit as shown in FIG. 2A. For convenience of illustration, only a drive transistor electrically connected to a first electrode 206a will be shown in FIG. 5.

The transistors 202 and the transistors 202′ included in the built-in circuit unit may be simultaneously (or currently or commonly) formed in the same layer. The transistors 202 and 202′ respectively include semiconductor layers 202a and 202a′ formed on a buffer layer 201 of the lower substrate 200a; gate electrodes 202b and 202b′ formed on the semiconductor layers 202a and 202a′ with a gate insulating layer 203 interposed therebetween; and source and drain electrodes 202c, 202d, 202c′, and 202d′ formed on the semiconductor layers 202a and 202a′ and the gate electrodes 202b and 202b′ with an interlayer insulating layer 204 interposed therebetween, and connected to the semiconductor layers 202a and 202a′ through contact holes that pass through the gate insulating layer 203 and the interlayer insulating layer 204.

A planarized insulating layer 205 is formed on the transistors 202 and 202′ of the pixel circuit and the built-in circuit unit. At this time, the planarized insulating layer 205 may formed into a stacked structure of an inorganic insulating layer 205a and an organic insulating layer 205b.

An organic light emitting diode OLED, OLED′ is formed on the planarized insulating layer 205. Here, the organic light emitting diode OLED, OLED′ includes a first electrode 206a, 206a′ (e.g., an anode electrode) electrically connected to the drive transistor 202; a light emitting layer 206b, 206b′ formed on the first electrode 206a, 206a; and a second electrode 206c, 206c (e.g., a cathode electrode) formed on the light emitting layer 206b, 206b′ and opposite to the first electrode 206a, 206a′.

Here, the first electrode 206a, 206a′ is patterned in the emission region for each of the pixels, and a pixel defining layer 207 is formed between the first electrodes 206a and 206a′ of the pixels. The pixel defining layer 207 is formed to overlap with an upper portion of an edge region of the first electrode 206a, and is formed to expose a portion of the first electrode 206a, 206a′ in the emission region of each of the pixels.

The light emitting layer 206b, 206b′ is formed in a region including the exposed region of the first electrode 206a, 206a′. Also, in the embodiment as shown, the second electrode 206c, 206c is not patterned for each of the pixels and is formed entirely on the pixel unit.

Here, each of the pixels emits light with luminance corresponding to current supplied from the drive transistor 202 in the overlapping region of the first and second electrodes 206a and 206c, particularly the area in which the organic light emitting diode OLED is formed by the overlapping of the first electrode 206a, the light emitting layer 206b and the second electrode 206c, thereby displaying an image.

In this embodiment, the emission regions of some of the pixels are disposed to overlap with the built-in circuit unit. The pixel circuit having the drive transistor 202 disposed in the same layer as the transistors 202′ in the built-in circuit unit is disposed to overlap with (or cross) the emission region, and the pixel circuit is not overlapped with the built-in circuit unit. The pixel circuit is formed to be electrically connected to the first electrode 206a in the emission region using an anode metal or the like.

More specifically, each of the pixels includes a pixel circuit including one or more transistors like the drive transistor 202; a first electrode 206a, 206a′ electrically connected to the pixel circuit above the pixel circuit; a second electrode 206c, 206c′ facing (or opposite to) the first electrode 206a, 206a′; and a light emitting layer 206b, 206b′ between the first electrode 206a, 206a′ and the second electrode 206b, 260b′. The emission region is defined in the overlapping region of the first and second electrodes 206a, 206a′ and 206c, 206c′.

In at least some of the pixels, the pixel circuit region having the pixel circuit formed therein is disposed to cross the emission region. Particularly, the emission region of the pixels is disposed to at least partially overlap with the pixel circuit region of a neighboring pixel or the built-in circuit unit.

That is, as shown in FIG. 5, in some of the pixels, the organic light emitting diode OLED connected to the drive transistor 202 formed in the pixel circuit region is disposed on the transistor 202′ of the built-in circuit unit, and an organic light emitting diode OLED′ of an adjacent pixel may be disposed at least partially overlapped above the drive transistor 202.

At this time, in the pixels disposed to overlap with the built-in circuit unit, the first and second electrodes 206a and 206c are at least partially overlapped with the built-in circuit unit. That is, at least some of the transistors 202′ provided to the built-in circuit unit may be disposed to overlap with some pixels below the first and second electrodes 206a and 206c of these pixels.

Particularly, when the pixel is a pixel of the organic light emitting display device as described above, the built-in circuit unit is disposed to overlap with the first electrodes 206a and the light emitting layers 206b and the second electrodes 206c of some pixels, so that the built-in circuit unit can be disposed to overlap with the emission regions of these pixels.

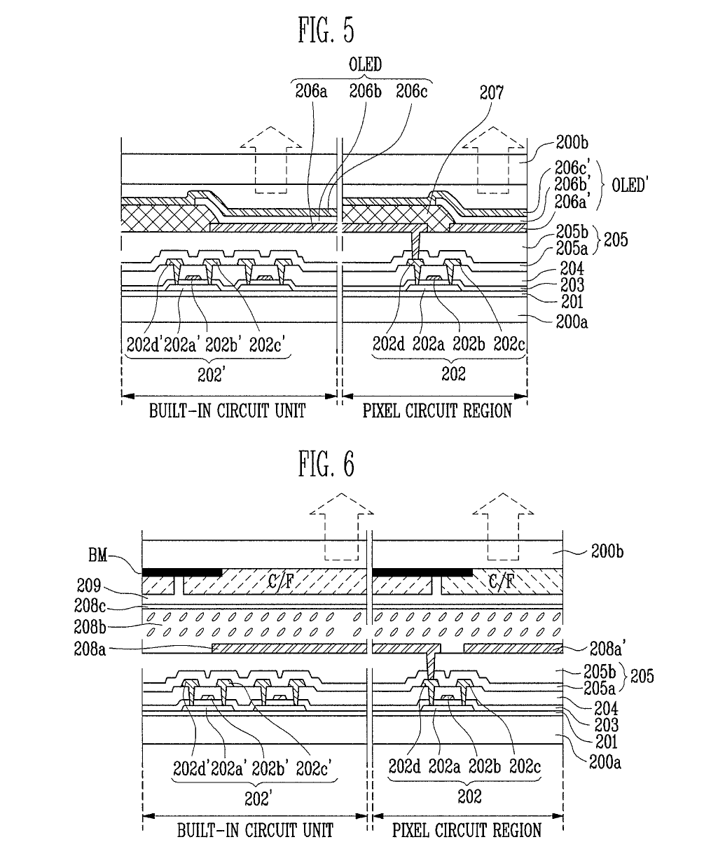

Also, the technical spirit of the present invention in which the emission regions of some of the pixels are disposed to overlap with the built-in circuit unit may be applied to other suitable flat panel display devices such as a liquid crystal display device. A liquid crystal display device according to an embodiment of the present invention will be described in more detail with reference to FIG. 6.

FIG. 6 is a sectional view showing another example of the panel shown in FIG. 3. Particularly, an example of the panel of the liquid crystal display device is shown in FIG. 6. In the description of FIG. 6, components identical or similar to those of FIG. 5 are designated by like reference numerals, and their detailed descriptions will be omitted.

Referring to FIG. 6, a first electrode 208a (hereinafter, referred to as a pixel electrode) and a second electrode 208c (hereinafter, referred to as a common electrode) are formed above the planarized insulating layer 205 formed on the transistors 202′ of the built-in circuit unit and the transistor 202 in the pixel circuit region. A liquid crystal layer 208b is interposed between the pixel and common electrodes 208a and 208c.

More specifically, each of the pixels includes a pixel circuit including one or more transistors 202 like the transistor TFT; a pixel electrode 208a, 208a′ electrically connected to the transistor 202 above the transistor 202; a common electrode 208c disposed on the pixel electrode 208a, 208a′ to be opposite to (or to face) the pixel electrode 208a, 208a′; and a liquid crystal layer 208b interposed between the pixel and common electrodes 208a, 208a′ and 208c.

Here, the pixel electrode 208a, 208a′ may be patterned for each of the pixels, and the liquid crystal layer 208b and the common electrode 208c may be formed entirely in the pixel unit. The emission region of each of the pixels is formed in the overlapping region of the pixel and common electrodes 208a and 208c to emit light, thereby displaying an image.

Here, the emission region of each of the pixels may be controlled by a color filter C/F and a black matrix BM, positioned on the common electrode 208c. Also, the color filter C/F and black matrix BM, the common electrode 208c and the like may be formed on the upper substrate 200b. An overcoat layer 209 may be further formed to separate the color filter C/F and black matrix BM from the common electrode 208c.

In this embodiment, the emission regions of some of the pixels may be disposed to overlap with the built-in circuit unit.

That is, the built-in circuit unit is disposed to overlap with some of (or a set of) the pixels and below the pixel electrode 208a, the liquid crystal layer 208b and the common electrode 208c of these pixels (or of the set of the pixels). Therefore, the built-in circuit unit may be disposed to at least partially overlap with the pixel unit in the interior of the pixel unit.

Also, in FIGS. 5 and 6, the connection line 242 shown in FIG. 4 is formed by extending the first electrode 206a or 208a, so that the pixel circuit region and the emission region, disposed to cross (or overlap with) each other, are electrically connected to each other. However, the present invention is not limited thereto but may be variously and suitably modified.

For example, the connection line 242 of FIG. 4 may be formed using a gate metal or the like formed of the same material in the same layer as the gate electrode 202b and the like. The connection line 242 may be electrically connected to the first electrode 206a or 208a through a contact hole.

When the connection line 242 is formed by extending the first electrode 206a or 208a, and the like, it is possible to reduce the complication of the design of the lower pixel circuit. When the connection line 242 is formed in the pixel circuit region using a gate metal or the like, it is possible to prevent an aperture ratio from being reduced.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A flat panel display device comprising:
a pixel unit comprising a plurality of pixels; and
a built-in circuit unit comprising a driver circuit configured to drive the pixels,
wherein the built-in circuit unit is disposed to partially overlap with the pixel unit.

2. The flat panel display device according to claim 1, wherein:
each of the pixels comprises:
a pixel circuit comprising one or more transistors,
a first electrode electrically connected to the pixel circuit and above the pixel circuit, and
a second electrode facing the first electrode; and
the built-in circuit unit is disposed to overlap with first and second electrodes of a set of the pixels.

3. The flat panel display device according to claim 2, wherein:
the built-in circuit unit comprises a plurality of transistors formed in the same layer as the one or more transistors of the pixel circuit; and
some of the plurality of transistors are disposed to overlap with the first and second electrodes of the set of the pixels and to be below the first and second electrodes.

4. The flat panel display device according to claim 2, wherein the pixels are configured to emit light in the overlapping region of the first and second electrodes so as to display an image.

5. The flat panel display device according to claim 1, wherein:
each of the pixels comprises:
a pixel circuit comprising a drive transistor, and
an organic light emitting diode comprising a first electrode electrically connected to the drive transistor and above the drive transistor, a light emitting layer on the first electrode, and a second electrode on the light emitting layer; and
the built-in circuit unit is disposed to overlap with the first electrodes, the light emitting layers and the second electrodes of some of the pixels.

6. The flat panel display device according to claim 1, wherein:
each of the pixels comprises:
a pixel circuit comprising one or more transistors,
a pixel electrode electrically connected to the one or more transistors and above the one or more transistors,
a common electrode facing the pixel electrode, and
a liquid crystal layer interposed between the pixel and common electrodes; and
the built-in circuit unit is disposed to overlap with the pixel electrodes, the liquid crystal layer and the common electrodes of some of the pixels.

7. The flat panel display device according to claim 1, wherein:
each of the pixels comprises:
a pixel circuit comprising one or more transistors,
a first electrode electrically connected to the pixel circuit and above the pixel circuit,
a second electrode facing the first electrode, and
an emission region formed in the overlapping region of the first and second electrodes; and
in at least a set of the pixels, pixel circuit regions having the pixel circuits formed therein and the emission regions are disposed to cross each other.

8. The flat panel display device according to claim 7, wherein the pitch of the emission regions is formed to be wider than that of the pixel circuit regions.

9. The flat panel display device according to claim 7, wherein the set of the pixels are disposed so that a corresponding pixel circuit region of the pixel circuit regions is not overlapped with a corresponding emission region of the emission regions, and each of the emission regions is disposed to at least partially overlap with a neighboring pixel region of the pixel regions or the built-in circuit unit.
